(19) United States
(12) Patent Application Publication
(10) Pub. No.: US 2026/0245807 A1
(43) Pub. Date: Aug. 20, 2026

(54) ELECTROLYTIC CAPACITOR COMPRISING AN ELECTRICALLY-CONDUCTIVE POLYMER COMPOUND AND METHOD FOR PRODUCING THE SAME

(71) Applicant: Rubycon Corporation, Ina-shi (JP)

(72) Inventors: Yoshishige SAKURAI, Ina-shi (JP); Akira IIJIMA, Ina-shi (JP)

(73) Assignee: Rubycon Corporation, Ina-shi (JP)

(21) Appl. No.: 19/054,139

(22) Filed: Feb. 14, 2025

(51) Int. Cl. H01G 9/035; H01G 9/00; H01G 9/025; H01G 9/145; H01G 9/15

(52) U.S. Cl. CPC H01G 9/035; H01G 9/0036; H01G 9/025; H01G 9/145; H01G 9/151

(57) ABSTRACT

An object of the present invention is to provide an electrically-conductive polymer compound which exhibits an excellent duration at high temperatures, wherein the electrolytic capacitor has an anode foil with an oxide film formed on the surface thereof, a cathode foil and a separator disposed between the anode foil and the cathode foil, wherein the electrolytic capacitor comprises, in a gap between the anode foil and the cathode foil: a solid electrolyte phase comprising an electrically-conductive polymer compound, and a liquid material phase comprising a liquid material,

characterized in that: the liquid material phase comprises an aromatic nitro compound in an amount of 1.0% by mass or more, the liquid material is polyethylene glycol and in the polyethylene glycol, the proportion of polyethylene glycol which is pentaethylene glycol or larger is 30% by mass or less.

### FIELD

The present invention relates to an electrolytic capacitor comprising an electrically-conductive polymer compound and a method for producing the same. In particular, the present invention relates to an electrolytic capacitor having a solid electrolyte phase comprising an electrically-conductive polymer compound and a liquid material phase containing a polyethylene glycol, and a method for producing the same.

### BACKGROUND

Conventionally, a solid electrolytic capacitor using an electrically-conductive polymer compound as an electrolyte (solid electrolyte) has been known. In addition, an electrolytic capacitor using, as an electrolyte, an electrically-conductive polymer compound and an electrolytic solution is known (hybrid type capacitor).

A nitro compound may be used in such an electrolytic capacitor comprising an electrically-conductive polymer compound, for the purpose of suppressing thermal deterioration, etc.

Patent Literature 1 describes a solid electrolytic capacitor comprising an electrically-conductive polymer layer, and describes that an electrically-conductive polymer layer is obtained using a mixed solution in which an electrically-conductive polymer compound is dispersed in a solution containing at least ethylene glycol and a nitro compound.

Patent Literature 2 describes an electrolytic capacitor comprising an electrically-conductive polymer and a conductive auxiliary liquid. The conductive auxiliary liquid comprises a high-boiling-point organic solvent having a boiling point of 150° C. or higher, and an aromatic compound having a nitro group and a carboxyl group or a carboxyl ester portion and not having a hydroxyl group.

Patent Literature 3 describes an electrolytic solution used in a hybrid electrolytic capacitor comprising an electrically-conductive polymer, and describes that the electrolytic solution has a first solvent comprising a lactone, a second solvent comprising a specific compound such as 1,3-propanediol, and an aromatic nitro compound.

Patent Literature 4 describes an electrolytic capacitor having a capacitor element, wherein it is described that the capacitor element is impregnated with a liquid comprising at least one of polyalkylene glycol and a derivative of polyalkylene glycol, and that the liquid further comprises an aromatic compound comprising a nitro group and at least one of a hydroxy group and a carboxyl group.

Patent Literature 5 describes an electrolytic capacitor having an anode body having a dielectric layer formed on a surface thereof, a solid electrolyte layer in contact with the dielectric layer and comprising an electrically-conductive polymer, and an electrolyte. The electrolyte comprises a first base component, a first acid component, and a second acid component. This document also describes that the solvent of the electrolyte may comprise a glycol compound and that a nitro compound may be contained as the third acid component.

It is also known that a water-soluble polymer compound in the liquid state is contained in a solid electrolytic capacitor comprising an electrically-conductive polymer.

Patent Literature 6 describes a solid electrolytic capacitor having a solid electrolyte made of a particulate electrically-conductive polymer compound and a water-soluble polymer solution which is composed of a water-soluble polymer compound in the form of liquid, water, and an alcohol having a nitro group, wherein the water-soluble polymer solution is introduced such that it surrounds the solid electrolyte.

### CITATION LIST

### Patent Literature

[Patent Literature 1] JP 2013-131514 A
[Patent Literature 2] JP 2015-2274 A
[Patent Literature 3] JP 2021-40036 A
[Patent Literature 4] U.S. Pat. No. 10,679,800 B
[Patent Literature 5] WO2019/225523A
[Patent Literature 6] JP 2018-26542 A

### SUMMARY

### Technical Problem

There were cases where the conventional electrolytic capacitor comprising an electrically-conductive polymer compound as a solid electrolyte exhibits insufficient durability at a high temperature.

An object of the present invention is to provide an electrolytic capacitor comprising an electrically-conductive polymer compound, which exhibits excellent durability at a high temperature.

### Solution to Problem

The above problem according to the present invention can be solved by the following inventions according to the present disclosure.

### Embodiment 1

An electrolytic capacitor having;
an anode foil with an oxide film formed on the surface thereof,
a cathode foil and
a separator disposed between the anode foil and the cathode foil,
wherein the electrolytic capacitor comprises, in a gap between the anode foil and the cathode foil:
a solid electrolyte phase comprising an electrically-conductive polymer compound, and
a liquid material phase comprising a liquid material, characterized in that:
the liquid material phase comprises an aromatic nitro compound in an amount of 1.0% by mass or more,
the liquid material is polyethylene glycol and
in the polyethylene glycol, the proportion of polyethylene glycol which is pentaethylene glycol or larger is 30% by mass or less.

### Embodiment 2

The electrolytic capacitor according to Embodiment 1, wherein the liquid material phase comprises water in an amount of 0.1% by mass to 10% by mass.

### Embodiment 3

The electrolytic capacitor of Embodiment 1 or 2, wherein the aromatic nitro compound is selected from the group consisting of nitrophenol, nitroacetophenone, nitrobenzyl alcohol, nitrobenzoic acid, and nitrobenzaldehyde.

### Embodiment 4

The electrolytic capacitor according to any one of Embodiments 1 to 3, wherein the solid electrolyte phase comprises polyethylene dioxythiophene as the electrically-conductive polymer compound and polystyrene sulfonic acid as a dopant.

### Embodiment 5

A method for manufacturing an electrolytic capacitor, comprising:
forming a capacitor element by superposing and winding an anode foil and a cathode foil via a separator, wherein the anode foil has an oxide film formed on the surface thereof and the cathode foil is optionally treated with an etching process;
impregnating the capacitor element with an aqueous solution or dispersion of an electrically-conductive polymer compound, in order to form a solid electrolyte phase in a gap between the anode foil and the cathode foil; and
after the formation of the solid electrolyte phase, impregnating the capacitor element with a liquid material phase comprising a liquid material, characterized in that:
the liquid material phase comprises an aromatic nitro compound in an amount of 1.0% by mass or more,
the liquid material is polyethylene glycol and
in the polyethylene glycol, the proportion of polyethylene glycol which is pentaethylene glycol or larger is 30% by mass or less.

### Advantageous Effects of the Invention

According to the electrolytic capacitor of the present invention, it is possible to provide an electrolytic capacitor having an electrically-conductive polymer compound, which exhibits excellent durability at a high temperature.

### BRIEF DESCRIPTION OF DRAWINGS

FIG. 1A is a schematic cross-sectional view of an electrolytic capacitor according to an embodiment of the present invention.

FIG. 1B is a schematic perspective view of a capacitor element according to an embodiment of the present invention.

FIG. 2 is a schematic cross-sectional view of the main portion of the solid electrolyte phase of FIG. 1.

### DESCRIPTION OF EMBODIMENTS

### <Capacitor>

The electrolytic capacitor according to the present invention has:
an anode foil with an oxide film formed on the surface thereof,
a cathode foil and
a separator disposed between the anode foil and the cathode foil,
   wherein the electrolytic capacitor comprises, in a gap between the anode foil and the cathode foil:
a solid electrolyte phase comprising an electrically-conductive polymer compound, and
a liquid material phase comprising a liquid material,
   characterized in that:
the liquid material phase comprises an aromatic nitro compound in an amount of 1.0% by mass or more,
the liquid material is polyethylene glycol and
in the polyethylene glycol, the proportion of polyethylene glycol which is pentaethylene glycol or larger is 30% by mass or less.

Conventionally, for an electrolytic capacitor comprising an electrically-conductive polymer compound as a solid electrolyte, polyethylene glycol (PEG) is sometimes used as a medium of an electrolytic liquid or a solution which is used together with an electrically-conductive polymer compound.

The inventors of the present invention have found that, in an electrolytic capacitor having a solid electrolyte phase comprising an electrically-conductive polymer compound and a liquid material phase comprising a liquid material, durability at high temperature is improved by optimizing the degree of polymerization (molecular weight) of polyethylene glycol contained in the liquid material phase, and thus have conceived of the present invention.

More specifically, it has been found that when the proportion of polyethylene glycol which is pentaethylene glycol or larger as the liquid material in polyethylene glycol is limited to a certain value or less, particularly good durability at high temperature can be obtained.

Without wishing to be bound by theory, it is believed that when the proportion of polyethylene glycol which is pentaethylene glycol or larger in polyethylene glycol is relatively low, an aromatic nitro compound is optimally arranged in a solid electrolyte phase comprising an electrically-conductive polymer compound, and as a result, the aromatic nitro compound (in particular, as a gas absorber) can more effectively suppress the thermal degradation.

More specifically, it is considered that, when the molecular weight of polyethylene glycol as the liquid material contained in the liquid material phase is relatively low, the degree of conformability of the polyethylene glycol to the electrically-conductive polymer compound (for example, PEDOT) constituting the solid electrolyte phase (in particular, the degree of penetration of the polyethylene glycol into the gap of the solid electrolyte phase formed from the electrically-conductive polymer compound) is improved. Since the liquid material phase comprises an aromatic nitro compound, it is believed that the degree of penetration of the aromatic nitro compound into the solid electrolyte phase increases as the degree of conformability of the polyethylene glycol to the solid electrolyte phase increases. On the other hand, when the molecular weight of polyethylene glycol contained in the liquid material phase is relatively high, it is believed that, for example, gaps in the solid electrolyte layer are blocked by the polyethylene glycol having a relatively large molecular weight, which in turn prevents the electrically-conductive polymer constituting the solid electrolyte from being in contact with, or in proximity to, the aromatic nitro compound.

It is believe that, when an aromatic nitro compound is better permeated into a solid electrolyte phase, the hydrogen gas generated due to a leakage current, etc. is more effectively removed by the aromatic nitro compound before the electrically-conductive polymer compound constituting the solid electrolyte phase is adversely affected, and as a result, the durability of the electrolytic capacitor is improved.

Exemplary embodiments according to the present invention will be described in more detail with reference to the drawings. It should be noted that the drawings and the exemplary embodiments do not limit the present invention. The drawings are schematic and not necessarily to scale.

### <Configuration of Electrolytic Capacitor 1 According to Embodiment>

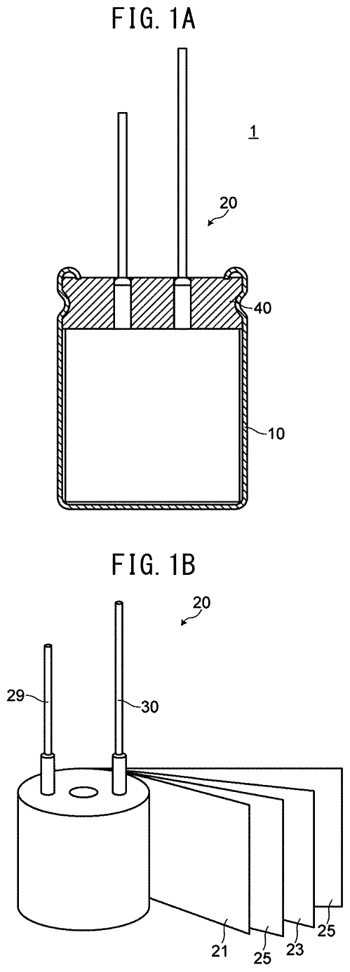

FIG. 1 is a diagram for explaining an electrolytic capacitor 1 according to an embodiment of the present invention. FIG. 1A is a cross-sectional view of the electrolytic capacitor 1, and FIG. 1B is a perspective view of the capacitor element 20.

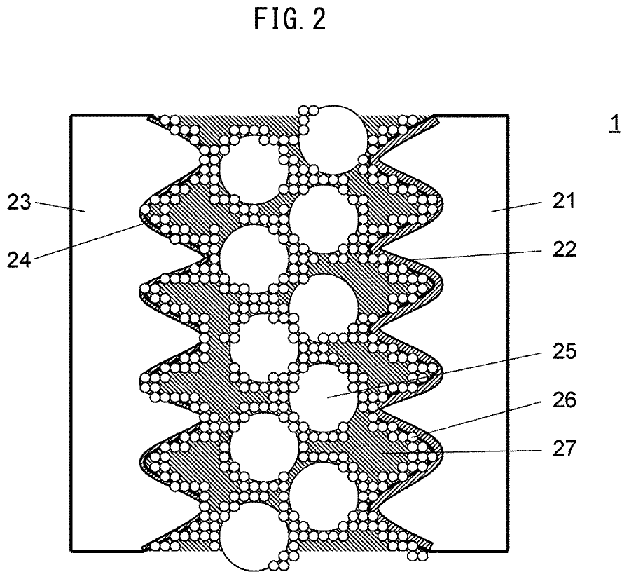

FIG. 2 is a diagram for explaining the main part of the electrolytic capacitor 1 according to an embodiment. FIG. 2 is a cross-sectional view of the main part of the electrolytic capacitor 1.

The electrolytic capacitor 1 according to an embodiment of the present invention is a wound-type electrolytic capacitor, and as shown in FIG. 1, comprises a bottomed cylindrical metal case 10, a capacitor element 20, and a sealing member 40.

The bottom surface portion of the metal case 10 has a substantially circular shape, and a valve (not shown) is provided near the center. Therefore, when the internal pressure increases, the valve breaks and the internal pressure can be released to the outside. The side surface portion of the metal case 10 is erected in a direction substantially perpendicular to the outer edge of the bottom surface portion. An opening of the metal case 10 is sealed by the sealing member 40, and two leads 29 and 30 of the capacitor element 20 are drawn to the outside via through-holes provided in the sealing member 40.

The capacitor element 20 is housed inside the metal case 10, and as shown in FIG. 1B and FIG. 2, it has an anode foil 21, a cathode foil 23, and a separator 25 disposed between the anode foil 21 and the cathode foil 23, wherein the anode foil 21 and the cathode foil 23 are superposed and wound via the separator 25.

In the embodiment depicted in FIG. 2, a solid electrolyte phase composed of a particulate electrically-conductive polymer compound 26 and a liquid material phase 27 comprising a liquid material are introduced into a gap between the anode foil 21 and the cathode foil 23, and the liquid material phase 27 is present so as to surround the solid electrolyte made of the electrically-conductive polymer compound 26. The anode foil 21 and the cathode foil 23 have oxide films 22 and 24 on their surfaces, respectively.

### <Gap>

In the present disclosure, the “gap between the anode foil and the cathode foil” includes not only the “gap between the anode foil and the separator and gap between the cathode foil and the separator” but also the “gap between the fibers in the separator”. The “gap between the anode foil and the cathode foil” also includes “a gap in an etching pit (recessed portion) on the surface of the anode foil or the cathode foil formed by roughening of the surface by an etching process”.

### <Liquid Material Phase>

The capacitor according to the present invention comprises a liquid material phase. The liquid material phase comprises at least a liquid material and an aromatic nitro compound.

The liquid material phase may be present so as to surround the solid electrolyte phase.

The liquid material phase is preferably composed essentially of liquid material and an aromatic nitro compound, and optionally water. In other words, the liquid material phase is preferably composed of a liquid material and an aromatic nitro compound and optional water, and contains components other than those in proportions of 10% by mass or less, 5% by mass or less, 2% by mass or less, 1% by mass or less, or even 0.1% by mass or less.

In the capacitor according to the present invention, the percentage of the liquid material phase in the gap between the anode foil and the cathode foil may be 10 vol % to 99 vol %, in particular 50 vol % to 99 vol %, or even 60 vol % to 99 vol %.

### (Liquid Material)

The liquid material contained in the liquid material phase is polyethylene glycol (PEG). The liquid material phase may sometimes contain ethylene glycol. When the liquid material phase comprises ethylene glycol, its content may be 5% by mass or less, or 1% by mass or less, based on the liquid material phase. In one preferred embodiment, the liquid material phase is free of ethylene glycol.

### (Polyethylene Glycol)

Polyethylene glycol (PEG) includes:
diethylene glycol (abbreviated as “PEG-2”),
triethylene glycol (abbreviated as “PEG-3”),
tetraethylene glycol (abbreviated as “PEG-4”),
pentaethylene glycol (abbreviated as “PEG-5”),
hexaethylene glycol (abbreviated as “PEG-6”),
heptaethylene glycol (abbreviated as “PEG-7”),
octaethylene glycol (abbreviated as “PEG-8”), and
nonaethylene glycol (abbreviated as “PEG-9”).
   Polyethylene glycol is not limited to these examples, and includes polyethylene glycol having a higher degree of polymerization (having a larger molecular weight) than the above-mentioned polyethylene glycols.

The liquid material (polyethylene glycol) may be a mixture of two or more polyethylene glycols having different molecular weights, or may be a single type of polyethylene glycol having a single molecular weight.

A mixture of two or more polyethylene glycols having different molecular weights can be made, for example, by mixing two or more polyethylene glycols each having a specific molecular weight (e.g., triethylene glycol, tetraethylene glycol).

In one of the preferred embodiments according to the present invention, the liquid material (polyethylene glycol) comprises a mixture of triethylene glycol (PEG-3) and tetraethylene glycol (PEG-4), or is essentially composed thereof (i.e., comprises 0.1% by mass or less of components other than these components).

The content of the liquid material (polyethylene glycol) is preferably from 80 to 99% by mass, more preferably from 85 to 98% by mass, still more preferably from 90 to 96% by mass, and particularly preferably from 92 to 95% by mass, based on the liquid material phase.

(Ratio of PEG with a Relatively Large Molecular Weight)

As described above, in the capacitor according to the present invention, the proportion of polyethylene glycol which is pentaethylene glycol or larger in the polyethylene glycol is 30% by mass or less.

This proportion may be 28 mass % or less, 26 mass % or less, 24 mass % or less, or 22 mass % or less.

In a particularly preferred embodiment of the present invention, the proportion of polyethylene glycol which is pentaethylene glycol or larger in the polyethylene glycol is 20% by mass or less, 15% by mass or less, 10% by mass or less, 5% by mass or less, or 1% by mass or less. The lower limit of this proportion is not particularly limited, but may be 0.1% by mass or more, 1% by mass or more, 2% by mass or more, 4% by mass or more, 6% by mass or more, 8% by mass or more, or 10% by mass or more.

Particularly preferably, polyethylene glycol is substantially free of polyethylene glycol which is pentaethylene glycol or larger. “Substantially free” means that the content of the component is 0.1% by mass or less.

There is no limitation for a method of producing the liquid material (polyethylene glycol) in which the proportion of polyethylene glycol which is pentaethylene glycol or a larger in the polyethylene glycol is 30% by mass or less. For example, it can be obtained by using only at least one of the polyethylene glycols smaller than pentaethylene glycol (diethylene glycol, triethylene glycol, and tetraethylene glycol).

Alternatively, a mixture of polyethylene glycols having more than 30% by mass of proportion of polyethylene glycol which is pentaethylene glycol or larger, or polyethylene glycol having a molecular weight equal to or larger than pentaethylene glycol, can be mixed with at least one of polyethylene glycols smaller than pentaethylene glycol (diethylene glycol, triethylene glycol, and tetraethylene glycol), such that the proportion of polyethylene glycol which is pentaethylene glycol or larger in the polyethylene glycol is 30% by mass or less.

### (Ratio of PEG Having Relatively Low Molecular Weight)

In a particularly preferred embodiment of the present invention, the proportion of polyethylene glycol which is tetraethylene glycol or smaller in the polyethylene glycol as the liquid material is 70% by mass or more, 75% by mass or more, 80% by mass or more, 85% by mass or more, 90% by mass or more, 95% by mass or more, 98% by mass or more, or 99% by mass or more. The upper limit of the proportion is not particularly limited, but may be less than 100% by mass, or less than 99.9% by mass.

### (Molecular Weight)

Preferably, the polyethylene glycol as the liquid material has an average molecular weight or a molecular weight which is less than 200. The average molecular weight or a molecular weight of polyethylene glycol as the liquid material is more preferably 190 or less, 180 or less, 170 or less, or 160 or less, and/or 100 or more, 110 or more, 120 or more, 130 or more, or 140 or more.

In the present disclosure, the “average molecular weight” of the polyethylene glycol as the liquid material can be calculated from the charge amount (ratio) of each polyethylene glycol used for preparing the polyethylene glycol as the liquid material. Alternatively, for the “average molecular weight” of the polyethylene glycol as the liquid material, the average molecular weight measured by GPC spectrometry (gel-permeation chromatography analysis) can be used.

### <Aromatic Nitro Compound>

The liquid material phase contains an aromatic nitro compound in an amount of 1.0% by mass or more. In this case, a capacitor having excellent durability at high temperature is obtained.

The aromatic nitro compound is an aromatic compound having a nitro group.

The aromatic nitro compound may be at least one selected from the group consisting of nitrophenol, nitroacetophenone, nitrobenzyl alcohol, nitrobenzoic acid, nitrobenzaldehyde, nitrobenzenecarboxylic acid, nitrobenzenedicarboxylic acid, nitroaniline, nitroanisol, nitrotoluene, nitroacetanilide, nitrocresol, nitrophenylacetic acid, methylnitrobenzoic acid, dinitrobenzoic acid, nitroterephthalic acid, and nitroisophthalic acid. These may be used alone or in combination of two or more.

Preferably, the aromatic nitro compound is at least one selected from the group consisting of nitrophenol, nitroacetophenone, nitrobenzyl alcohol, nitrobenzoic acid, and nitrobenzaldehyde.

The aromatic nitro compound is particularly preferably nitroacetophenone. When nitroacetophenone is used as the aromatic nitro compound, a capacitor having particularly good heat durability can be obtained.

The content of the aromatic nitro compound may be 1.1% by mass or more, 1.2% by mass or more, 1.3% by mass or more, 1.4% by mass or more, 1.5% by mass or more, 2% by mass or more, or 3% by mass or more, and/or may be 10% by mass or less, 8% by mass or less, or 6% by mass or less, based on the liquid material phase.

The content of the aromatic nitro compound is preferably 1.0 to 10% by mass, more preferably 1.2 to 8% by mass, and still more preferably 1.4 to 6% by mass, based on the liquid material phase. In this case, a capacitor having particularly excellent durability at high temperatures is obtained.

### <Water>

The liquid material phase can contain water.

If the liquid material phase existing in the gap between the anode foil and the cathode foil contains “water” in addition to the water-soluble polymer compound in the form of liquid, even when a defect occurs in an oxide film during the process of manufacturing an electrolytic capacitor, it is possible to use, in addition to a water content retained in the water-soluble polymer compound, a water derived from “water” for repairing the defect. As a result, particularly good effects can be obtained with respect to the reduction of a defect density of an oxide film and the reduction of a leakage current.

The water content may be from 0% to 10% by mass, preferably from 0.1% to 10% by mass, more preferably from 0.5% to 5% by mass, based on the liquid material phase. When the water content is in this range, it is possible to sufficiently obtain a repairing effect of a defect in an oxide film, and it may be possible to avoid or reduce an adverse effect caused by excess amount of water content (such as expansion of a capacitor that may occur when used for a long period of time in a high-temperature environment).

In addition to the liquid material and the aromatic nitro compound, the liquid material phase can also contain an ionic compound. The ionic compound includes organic salt. The organic salt refers to salt in which at least one of a base and an acid constituting the salt is an organic substance. It should be noted that in one embodiment according to the present invention, the liquid material phase comprises a liquid material and an aromatic nitro compound, while not comprising an ionic compound (in particular, organic salt).

### <Anode Foil>

The capacitor according to the present invention comprises an anode foil having an oxide film formed on the surface thereof.

The anode foil may be formed from a valve metal such as aluminum, tantalum, niobium, etc.

The anode foil has an oxide film on the surface thereof. For example, an oxide film can be formed on the surface of the anode foil, in accordance with a known method, by way of roughening treatment by an etching process and a subsequent chemical treatment.

### <Cathode Foil>

The capacitor according to the present invention comprises a cathode foil.

As in the case of the anode foil, the cathode foil may be formed from a valve metal such as aluminum, tantalum, niobium, etc.

An oxide film may be formed on the surface of the cathode foil. For example, as in the case of the anode foil, the surface of a cathode foil may be roughened by an etching process and then an oxide film may be formed by natural oxidation. In addition, the cathode foil may be subjected to a chemical treatment at a desired voltage (for example, 2V), whereby an oxide film may be formed.

### <Separator>

The capacitor according to the present invention comprises a separator. The separator is disposed between the anode foil and the cathode foil.

The separator preferably includes those formed of a synthetic resin such as a cellulose fiber which is chemically compatible with electrically-conductive polymer particles and/or a water-soluble polymer; nylon, which is excellent in heat resistance; PET; and PPS. For example, a heat-resistant cellulose paper or a heat-resistant flame retardant paper can be used. More specifically, examples of the separator include cellulose and mixed paper thereof, polyester resins, polyamide resins, polyimide resins, polyethylene resins, polypropylene resins, polyphenylene sulfide resins, acrylic resins, polyvinyl alcohol resins, and trimethylpentene resins, and these resins can be used alone or in combination. Further examples include polytetrafluoroethylene-based resins, polyvinylidene fluoride-based resins, and vinylon-based resins. Examples of the polyester resin include polyethylene terephthalate, polybutylene terephthalate, polyethylene naphthalate, and derivatives thereof. Examples of the polyamide-based resin include aliphatic polyamide, semi-aromatic polyamide, and wholly aromatic polyamide. Cellulose includes kraft, manila hemp, esparto, hemp, and rayon.

### <Solid Electrolyte Phase>

The capacitor according to the present invention comprises a solid electrolyte phase in the gap between the anode foil and the cathode foil.

### (Electrically-Conductive Polymer Compound)

The solid electrolyte phase comprises an electrically-conductive polymer compound, and in particular, it is substantially composed of an electrically-conductive polymer compound.

The electrically-conductive polymer compound includes at least one selected from polythiophene, polypyrrole, and polyalanine, and derivatives thereof. The electrically-conductive polymer compound may be at least one of these materials. A preferred electrically-conductive polymer compound is polyethylenedioxythiophene (PEDOT) (in particular, poly(3,4 ethylenedioxythiophene)).

The solid electrolyte phase may further comprise a dopant. The dopant includes polystyrenesulfonic acid (PSS), toluenesulfonic acid, alkylbenzenesulfonic acid, and naphthalenesulfonic acid, and derivatives thereof. One of these may be used alone, or two or more of them may be used in combination.

The polystyrene sulfonic acid preferably has a weight average molecular weight of 10,000 to 1,000,000.

In a preferred embodiment, the solid-electrolyte phase comprises polyethylenedioxythiophene (PEDOT) and, as a dopant, polystyrenesulfonic acid (PSS).

The electrically-conductive polymer compound may be in the form of fine particles. The mean particle size of the electrically-conductive polymer compound in the form of fine particles is preferably in the range of 1 nm to 300 nm, or even 5 nm to 200 nm (e.g., 20 nm).

In the capacitor according to the present invention, the proportion of the electrically-conductive polymer compound in the gap between the anode foil and the cathode foil may be 0.5 vol % to 20 vol %, or even 1 vol % to 10 vol %.

### (Formation of Solid Electrolyte Phase)

The method of forming the solid electrolyte phase containing the electrically-conductive polymer compound is not particularly limited, but can be formed by, for example, an immersion impregnation method. For example, the solid electrolyte phase can be formed by filling a gap using a dispersion (dispersion liquid of electrically-conductive polymer compound) in which an electrically-conductive polymer compound is dispersed in a dispersion medium, or using a solution (a solution of electrically-conductive polymer compound) in which an electrically-conductive polymer compound is dissolved in a solvent, and then removing the dispersion medium or the solvent from the gap by heat drying, etc.

More specifically, for example, the capacitor element is immersed in a dispersion of electrically-conductive polymer compound or a solution of electrically-conductive polymer compound, using an introduction tank. Afterwards, the capacitor element is taken out from the dispersion of electrically-conductive polymer compound or the solution of electrically-conductive polymer compound and the capacitor element is subjected to heat treatment, in order to form a solid electrolyte phase. This operation may be repeated multiple times, thereby increasing the filled amount of the solid electrolyte phase.

Alternatively, the solid electrolyte phase containing an electrically-conductive polymer compound may be formed by polymerizing monomers by way of a so-called “in situ polymerization”.

The content of the electrically-conductive polymer in a dispersion of electrically-conductive polymer compound or a solution of electrically-conductive polymer compound may be 0.1 to 10% by mass, particularly 1 to 3% by mass.

As a dispersion medium for a dispersion of electrically-conductive polymer compound, for example, water, a protic solvent such as an alcohol (methanol, ethanol, 1-propanol, or butanol) and a mixture thereof, etc., can be used. As a solvent for a solution of electrically-conductive polymer compound, for example, water, a protic solvent such as an alcohol (methanol, ethanol, 1-propanol, or butanol) and a mixture thereof, etc., can be used. A dispersion of electrically-conductive polymer compound or a solution of electrically-conductive polymer compound solution may contain an aromatic nitro compound.

The dispersion of electrically-conductive polymer compound or the solution of electrically-conductive polymer compound may contain other compound(s) as an additive, and may contain, for example, a compound having a high boiling point (in particular, a compound having a boiling point of 150° C. or higher). The additive includes polyols (such as ethylene glycol, polyethylene glycol, and derivatives thereof; glycerin, diglycerin, polyglycerin, and derivatives thereof), sugar alcohols (such as sorbitol, mannitol), γ-butyrolactone, butanediol, dimethyl sulfoxide, sulfolane, N-methylpyrrolidone, dimethyl sulfolane, etc. These may be used alone or in combination of two or more.

The content of the additive in a dispersion of electrically-conductive polymer compound or a solution of electrically-conductive polymer compound may be from 1 to 40% by mass, in particular from 2 to 30% by mass, or even from 5 to 25% by mass. The content of the additive may even be from 1 to 20% by mass.

### <Capacitor>

### (CAP)

The capacitor according to the present invention may have a capacity of 200 to 400 μF, or even 220 to 350 μF, as measured at 120 Hz according to the method described in the example section.

(tan δ)

The capacitor according to the present invention may have tan δ of 0.5 to 4.0%, or even 1.0 to 3.0%, as measured at 120 Hz according to the method described in the example section.

### (ESR)

The capacitor according to the present invention may have an ESR of 5 to 30 mΩ, or even 8 to 20 mΩ, as measured at 100 kHz according to the method described in the example section.

### <Method for Manufacturing Capacitor>

The method for manufacturing the capacitor according to the present invention is not particularly limited. The capacitor according to the present invention can be produced, in particular, by the following production method according to the present invention:
a method for manufacturing an electrolytic capacitor, comprising:
forming a capacitor element by superposing and winding an anode foil and a cathode foil via a separator, wherein the anode foil has an oxide film formed on the surface thereof and the cathode foil is optionally treated with an etching process;
impregnating the capacitor element with an aqueous solution or dispersion of an electrically-conductive polymer compound, in order to form a solid electrolyte phase in a gap between the anode foil and the cathode foil; and
after the formation of the solid electrolyte phase, impregnating the capacitor element with a liquid material phase comprising a liquid material,
   characterized in that:
the liquid material phase comprises an aromatic nitro compound in an amount of 1.0% by mass or more,
the liquid material is polyethylene glycol and
in the polyethylene glycol, the proportion of polyethylene glycol which is pentaethylene glycol or larger is 30% by mass or less.

For details of each component of this manufacturing method according to the present invention (for example, anode foil, cathode foil, solid electrolyte phase, liquid material phase, liquid material, etc.), reference can be made to the above description of the electrolytic capacitor according to the present invention.

A method for manufacturing an electrolytic capacitor according to an exemplary embodiment will be described below. This exemplary manufacturing method includes a step of forming a capacitor element, a step of chemical treatment, a step of introducing a solid electrolyte phase, a step of introducing a liquid material phase, and a step of assembly and sealing.

### (1) Step of Forming a Capacitor Element

In an exemplary method for an electrolytic capacitor, an aluminum foil is first provided as an anode foil 21. After the surface of the aluminum foil has been roughened by the surface expansion process, a 2V to 500V of predetermined voltage is applied to the surface of the roughened aluminum foil, in order to perform a chemical treatment, thereby forming an oxide film 22 on the surface of the aluminum foil. Subsequently, a capacitor element which comprises an anode foil 21 having an oxide film 22, an optionally etched cathode foil 23, and a separator 25 disposed between the anode foil 21 and the cathode foil 23 (see FIG. 1B) is formed. More specifically, the anode foil 21 having the roughened surface (rough surface) and the oxide film 22 formed thereon and the cathode foil 23 having the roughened surface are superposed and wound via the separator 25, in order to form the capacitor element 20. During this process, a lead 30 is connected to the anode foil 21, and a lead 29 is connected to the cathode foil 23.

### (2) A Step of Chemical Treatment

Next, the capacitor 20 is immersed in a chemical treatment solution held in a chemical treatment solution tank, and a predetermined voltage (e.g., 100V) is applied between the anode-side lead 30 and the chemical treatment solution for 5 minutes. This operation repairs a defective portion in the oxide film at an edge portion of the anode foil 21 and a defective portion of the oxide film which may exist on the surface.

As the chemical treatment solution, a chemical treatment liquid (for example, an aqueous solution of ammonium adipate, ammonium borate, ammonium phosphate, ammonium glutarate, ammonium azelate, ammonium tartrate, ammonium sebacate, ammonium pimelate, ammonium suberate, etc.) can be used.

### (3) Step of Introducing a Solid Electrolyte Phase

Next, a solid electrolyte phase composed of an electrically-conductive polymer compound 26 in the form of fine particles is introduced into the gap between the anode foil 21 and the cathode foil 23 such that the proportion of the solid electrolyte phase in the gap is, for example, within the range of 2 vol % to 30 vol %. In the step of introducing a solid electrolyte phase, the solid electrolyte phase can be introduced into the gap by, for example, filling the gap with a dispersion of electrically-conductive polymer compound in which the electrically-conductive polymer compound is dispersed in a dispersion medium, and then removing the dispersion medium from the gap. Instead of a dispersion of electrically-conductive polymer compound, a solution in which an electrically-conductive polymer compound is dissolved in a solvent (a solution of electrically-conductive polymer compound) may also be used.

More specifically, the step of introducing a solid electrolyte phase can be performed by an immersion impregnation method. In other words, a dispersion of electrically-conductive polymer compound (for example, with a polymer concentration of 2 vol %) is filled in an introduction tank, and then a capacitor element is immersed in the dispersion of electrically-conductive polymer compound. Next, the capacitor element is taken out from the introduction tank, and thereafter, the capacitor element is heat-treated.

The dispersion of electrically-conductive polymer compound can be prepared by polymerizing (radically polymerizing or oxidatively polymerizing) a monomer (e.g., a PEDOT monomer) in suspension to prepare an electrically-conductive polymer compound in the form of fine particles made of an electrically-conductive polymer compound (e.g., a PEDOT polymer) to which a dopant or an emulsifying agent is added; and by dispersing the electrically-conductive polymer compound in the form of fine particles in a given dispersion medium. The average particle diameter of an electrically-conductive polymer compound can be adjusted by appropriately setting the polymerization reaction conditions (for example, the concentration of an initiator, a monomer, a polymerization auxiliary agent, etc., reaction temperature, stirring conditions of a reaction solution, etc.). Further, it can also be adjusted by performing a known grinding process (e.g., stirring ground process, vibration pulverization process, etc.). In addition, the particle size can be made uniform by the preparative filtration process.

In order to increase the proportion of a solid electrolyte phase in the gap, the number of repetitions of the above operation can be increased, and/or the polymer concentration in a dispersion of electrically-conductive polymer compound can be increased. On the other hand, in order to reduce the proportion of a solid electrolyte phase in the gap, the number of repetitions of the above operation can be reduced, and/or the polymer concentration in a dispersion of electrically-conductive polymer compound can be reduced.

### (4) A Step of Introducing a Liquid Material Phase

In the step of introducing a liquid material phase, for example, the liquid material phase 27 is introduced into the gap between the anode foil 21 and the cathode foil 23 such that the liquid material phase surrounds the solid-state electrolyte and such that the proportion of the liquid material phase 27 in the gap is within a range of 10 vol % to 99 vol %. More specifically, the step of introducing a liquid material phase can be performed as described in (a) and (b) below.

### (a) Preparation of Liquid Material Phase

A liquid material phase can be prepared by providing a liquid material (polyethylene glycol); adding an aromatic nitro compound and optionally water to the liquid material; and then stirring. These operations may be carried out, for example, at 40° C.

### (b) Introduction of Liquid Material Phase

If a liquid material phase is filled by an immersion impregnation method, the liquid material phase is introduced into the gap by filling an introduction tank with the liquid material phase and then immersing a capacitor element in the liquid material phase.

### (5) Step of Assembly and Sealing

In the step of assembly and sealing, the sealing member 40 is attached to the capacitor element 20, and after the capacitor element 20 is inserted into the metal case 10, the metal case 10 is crimped at a portion near an open edge thereof. As the sealing member 40, for example, isobutylene-isoprene rubber (IIR) can be used. Instead of the isobutylene-isoprene rubber (IIR), a rubber material such as ethylene-propylene terpolymer (EPT), EPT-IR blended rubber, or silicone rubber, or a rubber composite material in which a resin such as a phenolic resin (bakelite), an epoxy resin, or a fluororesin is bonded to a rubber, can also be used. As an optional step thereafter, an aging step is performed by applying a predetermined voltage under a high-temperature atmosphere. Consequently, the electrolytic capacitor 1 according to the embodiment of the present invention is formed.

### EXAMPLES

Embodiments of the present invention will now be described in more detail with reference to examples. The following examples and comparative examples do not limit the present invention.

### <Measurement Method>

The measurement methods performed in Examples and Comparative Examples are as follows.

### <CAP>

CAP (μF) of a capacitor was measured at 120 Hz in a constant-temperature bath at 25° C. using an LCR meter (Precision LCR Meter (E4980A) manufactured by Keysight Technologies).

### <Tan δ>

The tan δ (%) of a capacitor was measured at 120 Hz in a constant-temperature bath at 25° C. using an LCR meter (Precision LCR Meter (E4980A) manufactured by Keysight Technologies).

### <ESR>

ESR (mΩ) of a capacitor was measured at 100 kHz in a constant-temperature bath at 25° C. using an LCR meter (Precision LCR Meter (E4980A) manufactured by Keysight Technologies).

### <Average Molecular Weight>

Mean molecular weight of polyethylene glycol was measured by a GPC method using a high-speed liquid chromatograph (Prominence, manufactured by Shimadzu Corporation).

### Examples 1 to 5 and Comparative Examples 1 to 2

In Examples 1 to 5 and Comparative Examples 1 to 2, evaluations were conducted with regard to a composition of polyethylene glycol contained in a liquid material phase of a capacitor.

### Example 1

### (Production of Capacitor)

An anode foil (made of aluminum) having about 60V withstand voltage and a cathode foil (made of aluminum) were wound (rolled up) via a separator (made of cellulose), then edge faces and defective portions were chemically treated using a chemical treatment liquid, and then a solid electrolyte was vacuum-impregnated and dried, in order to form a capacitor element having a solid electrolyte phase. The solid-electrolyte phase had polyethylenedioxythiophene (PEDOT) as an electrically-conductive polymer compound and polystyrenesulfonic acid (PSS) as a dopant. The capacitor element was impregnated with a liquid which constitutes a liquid material phase, in order to obtain the capacitor according to Example 1.

The composition of the liquid material phase of the capacitor according to Example 1 was as follows:
94% by mass of tetraethylene glycol (PEG-4) (molecular weight 194.23)
5% by mass of nitroacetophenone
1 mass % water

In the liquid material phase according to Example 1, the proportion of polyethylene glycol which is pentaethylene glycol (PEG-5) or larger in the polyethylene glycol was 0% by mass.

### <Performance Evaluation (Initial Value)>

The capacitor according to Example 1 thus obtained was subjected to each of an initial performance evaluation and a performance evaluation after durability test.

In the durability test, the performance of the capacitor was evaluated after the capacitor was allowed to stand at 135° C. for 500 hours with a voltage of 42V being applied to the capacitor.

The results according to Example 1 are shown in Table 1 below.

### Example 2

The capacitor according to Example 2 was manufactured and the performance of the capacitor was evaluated in the same manner as in Example 1, except that a mixture of PEG-4 and PEG-3 (triethylene glycol, molecular weight: 150.17) (weight ratio: 2:8) was used instead of PEG-4 as above. In the liquid material phase according to Example 2, the proportion of polyethylene glycol which is pentaethylene glycol (PEG-5) or larger in the polyethylene glycol was 0% by mass. The results are shown in Table 1 below.

### Example 3

The capacitor according to Example 3 was manufactured and the performance of the capacitor was evaluated in the same manner as in Example 1, except that PEG-3 was used instead of PEG-4 as above. In the liquid material phase according to Example 3, the proportion of polyethylene glycol which is pentaethylene glycol (PEG-5) or larger in the polyethylene glycol was 0% by mass. The results are shown in Table 1 below.

### Example 4

The capacitor according to Example 4 was manufactured and the performance of the capacitor was evaluated in the same manner as in Example 1, except that PEG-2 (diethylene glycol, molecular weight: 106.12) was used instead of PEG-4 as above. In the liquid material phase according to Example 4, the proportion of polyethylene glycol which is pentaethylene glycol (PEG-5) or larger in the polyethylene glycol was 0% by mass. The results are shown in Table 1 below.

### Example 5

The capacitor according to Example 5 was manufactured and the performance of the capacitor was evaluated in the same manner as in Example 1, except that a mixture of PEG-4 and PEG200 (weight ratio: 5:5) was used instead of PEG-4 as above.

PEG200 used in Example 5 had a molecular weight distribution, i.e., it was a mixture of a plurality of polyethyleneglycols with varying degrees of polymerisation. In the liquid material phase according to Example 5, the proportion of polyethylene glycol which is pentaethylene glycol (PEG-5) or larger in the polyethylene glycol was 21.6% by mass, as measured by gel chromatography (GPC method). The results are shown in Table 1 below.

### Comparative Example 1

The capacitor according to Comparative Example 1 was manufactured and the performance of the capacitor was evaluated in the same manner as in Example 1, except that PEG300 was used instead of PEG-4 as above.

PEG300 used in Comparative Example 1 had a molecular weight distribution, i.e., it was a mixture of a plurality of polyethylene glycols having different degrees of polymerization. In the liquid material phase according to Comparative Example 1, the proportion of polyethylene glycol which is pentaethylene glycol (PEG-5) or larger in the polyethylene glycol was 79.6% by mass, as measured by gel chromatography (GPC method). The results are shown in Table 1 below.

### Comparative Example 2

The capacitor according to Comparative Example 2 was manufactured and the performance of the capacitor was evaluated in the same manner as in Example 1, except that PEG200 was used instead of PEG-4 as above. In the liquid material phase according to Comparative Example 2, the proportion of polyethylene glycol which is pentaethylene glycol (PEG-5) or larger in the polyethylene glycol was 43.3% by mass, based on a molecular weight distribution measured by gel chromatography. The results are shown in Table 1 below.

### Reference Example 1

The capacitor according to Reference Example 1 was manufactured and the performance of the capacitor was evaluated in the same manner as in Example 1, except that ethylene glycol (EG) was used instead of PEG-4 as above.

TABLE 1

| | | | | | | | Evaluation results (135° C. 500 hours) | | | | | | | | |
|---|---|---|---|---|---|---|---|---|---|---|---|---|---|---|---|
| | | | | | | | CAP (120 Hz) | | | | | | | | |
| | | | | | | | | | (After | tan δ (120 Hz) | | | ESR (100 kHz) | | |
| | Composition | | | | | | | | durability | | | (After | | | (After |
| | PEG | | | | | | | | test - | | | dura- | | | dura- |
| | | | Ratio | | | | | | Before | | | bility | | | bility |
| | | | of | | | | | | durability | | | test/ | | | test/ |
| | | | PEG-5 | Percent- | Nitro | | | After | test)/ | | After | Before | | After | Before |
| | | | and | age of | aceto- | | | dura- | Before | | dura- | dura- | | dura- | dura- |
| | | Molecular | larger | content | phenone | water | Ini- | bility | durability | Ini- | bility | bility | Ini- | bility | bility |
| | Type | weight | mass | mass | mass | mass | tial | Test | test | tial | Test | test | tial | Test | test |
| | — | — | % | % | % | % | μF | μF | % | % | % | — | mΩ | mΩ | — |
| Ex. 1 | PEG-4 | 194.23 | 0 | 94.0 | 5.0 | 1.0 | 255.4 | 224.9 | −11.94 | 2.18 | 2.94 | 1.35 | 11.14 | 14.88 | 1.34 |
| Ex. 2 | PEG-4 + | 158.98 | 0 | 94.0 | 5.0 | 1.0 | 255.4 | 225.9 | −11.56 | 2.14 | 2.81 | 1.31 | 11.16 | 14.35 | 1.29 |
| | PEG-3 | | | | | | | | | | | | | | |
| | (2:8) | | | | | | | | | | | | | | |
| Ex. 3 | PEG-3 | 150.17 | 0 | 94.0 | 5.0 | 1.0 | 255.4 | 226.9 | −11.18 | 2.10 | 2.68 | 1.28 | 11.19 | 13.81 | 1.23 |
| Ex. 4 | PEG-2 | 106.12 | 0 | 94.0 | 5.0 | 1.0 | 258.2 | 229.4 | −11.13 | 2.05 | 2.71 | 1.32 | 11.11 | 14.37 | 1.29 |
| Ex. 5 | PEG200 + | Approx. 197 | 21.6 | 94.0 | 5.0 | 1.0 | 255.3 | 224.7 | −11.98 | 2.19 | 2.98 | 1.36 | 11.04 | 14.98 | 1.36 |
| | PEG-4 | | | | | | | | | | | | | | |
| | (5:5) | | | | | | | | | | | | | | |
| Comp. | PEG300 | Approx. 300 | 79.6 | 94.0 | 5.0 | 1.0 | 256.2 | 220.8 | −13.83 | 2.30 | 4.07 | 1.77 | 11.01 | 26.58 | 2.41 |
| Ex. 1 | | | | | | | | | | | | | | | |
| Comp. | PEG200 | Approx. 200 | 43.3 | 94.0 | 5.0 | 1.0 | 255.4 | 224.4 | −12.13 | 2.20 | 3.04 | 1.38 | 11.02 | 15.34 | 1.39 |
| Ex. 2 | | | | | | | | | | | | | | | |
| Ref. | EG | 62.07 | 0 | 94.0 | 5.0 | 1.0 | 261 | 121.7 | −53.38 | 2.08 | 242.4 | 116.4 | 10.69 | 9895 | 925 |
| Ex. 1 | | | | | | | | | | | | | | | |

“Molecular weight” in Ex. 5 and Comp. Ex. 1 to 2 indicates an average molecular weight measured by GPC analysis.

It is understood from Tables 1 that, by use of nitroacetophenone as the aromatic nitro compound and the relatively lower percentage (by mass) of polyethylene glycol which is PEG-5 or larger, it is possible to maintain the characteristics as a capacitor even after the durability test.

### Example 6 and Comparative Example 3

In Example 6 and Comparative Example 3, evaluations were performed for cases where the content of nitroacetophenone, which was contained as an aromatic nitro compound in the liquid material phase of the capacitor, was 10% by mass and 0% by mass, respectively.

### Example 6

The capacitor according to Example 6 was manufactured and the performance of the capacitor was evaluated in the same manner as in Example 3, except that the contents of nitroacetophenone (10% by mass) and PEG-3 were changed. In the liquid material phase according to Example 6, the proportion of polyethylene glycol which is pentaethylene glycol (PEG-5) or larger in the polyethylene glycol was 0% by mass. The results are shown in Table 2 below.

### Comparative Example 3

The capacitor according to Comparative Example 3 was manufactured and the performance of the capacitor was evaluated in the same manner as in Example 6, except that nitroacetophenone was not contained. In the liquid material phase according to Comparative Example 3, the proportion of polyethylene glycol which is pentaethylene glycol (PEG-5) or larger in the polyethylene glycol was 0% by mass. The results are shown in Table 2 below.

TABLE 2

| | | | | | Evaluation results (135° C. 500 hours) | | | | | | | | |
|---|---|---|---|---|---|---|---|---|---|---|---|---|---|
| | | | | | CAP (120 Hz) | | | tan δ (120 Hz) | | | ESR (100 kHz) | | |
| | | | | | | | (After | | | (After | | | (After |
| | Composition | | | | | | durability | | | durability | | | durability |
| | | Aromatic nitro | | | | After | test - Before | | After | test/ | | After | test/- |
| | PEG-3 | compound | | water | | Dura- | durability | | Dura- | Before | | dura- | Before |
| | Content | | Content | Content | | bility | test)/Before | | bility | durability | | bility | durability |
| | mass | Type | mass | mass | Initial | Test | durability test | Initial | Test | test | Initial | Test | test |
| | % | — | % | % | [μF] | [μF] | [%] | [%] | [%] | — | [mΩ] | [mΩ] | — |
| Ex. 3 | 94.0 | Nitro | 5.0 | 1.0 | 255.4 | 226.9 | −11.18 | 2.10 | 2.68 | 1.28 | 11.19 | 13.81 | 1.23 |
| | | aceto- | | | | | | | | | | | |
| | | phenone | | | | | | | | | | | |
| Ex. 6 | 89.0 | Nitro | 10.0 | 1.0 | 255.5 | 225.4 | −11.78 | 2.14 | 2.82 | 1.32 | 11.12 | 13.98 | 1.26 |
| | | aceto- | | | | | | | | | | | |
| | | phenone | | | | | | | | | | | |
| Comp. | 99.0 | — | 0.0 | 1.0 | 255.0 | 35.8 | −85.96 | 2.10 | 238.0 | 113.3 | 11.06 | 34277 | 3099 |
| Ex. 3 | | | | | | | | | | | | | |

From Table 2, it is understood that the effect shown in Table 1, i.e. the effect that the properties as a capacitor were well maintained even after the durability test by using nitroacetophenone as an aromatic nitro compound and a lower ratio (mass %) of PEG-5 or larger, is obtained when the nitroacetophenone content is 5 or 10% by mass, whereas the effect is not obtained when the nitroacetophenone is not contained.

### Examples 7 to 12

In Examples 7 to 12, evaluations were performed for cases where an aromatic nitro compound other than nitroacetophenone was used as an aromatic nitro compound which is contained in the liquid material phase of a capacitor.

### Example 7

The capacitor according to Example 7 was manufactured and the performance of the capacitor was evaluated in the same manner as in Example 3, except that nitrobenzoic acid was used instead of nitroacetophenone. In the liquid material phase according to Example 7, the proportion of polyethylene glycol which is pentaethylene glycol (PEG-5) or larger in the polyethylene glycol was 0% by mass. The results are shown in Table 3 below.

### Example 8

The capacitor according to Example 8 was manufactured and the performance of the capacitor was evaluated in the same manner as in Example 3, except that nitrobenzyl alcohol was used instead of nitroacetophenone. In the liquid material phase according to Example 8, the proportion of polyethylene glycol which is pentaethylene glycol (PEG-5) or larger in the polyethylene glycol was 0% by mass. The results are shown in Table 3 below.

### Example 9

The capacitor according to Example 9 was manufactured and the performance of the capacitor was evaluated in the same manner as in Example 8, except that the contents of nitrobenzyl alcohol (10% by mass) and PEG-3 were changed. In the liquid phase according to Example 9, the proportion of polyethylene glycol which is pentaethylene glycol (PEG-5) or larger in the polyethylene glycol was 0% by mass. The results are shown in Table 3 below.

### Example 10

The capacitor according to Example 10 was manufactured and the performance of the capacitor was evaluated in the same manner as in Example 3, except that nitrophenol was used instead of nitroacetophenone. In the liquid phase according to Example 10, the proportion of polyethylene glycol which is pentaethylene glycol (PEG-5) or larger in the polyethylene glycol was 0% by mass. The results are shown in Table 3 below.

### Example 11

The capacitor according to Example 11 was manufactured and the performance of the capacitor was evaluated in the same manner as in Example 10, except that the contents of nitrophenol (10% by mass) and PEG-3 were changed. In the liquid material phase according to Example 11, the proportion of polyethylene glycol which is pentaethylene glycol (PEG-5) or larger in the polyethylene glycol was 0% by mass. The results are shown in Table 3 below.

### Example 12

The capacitor according to Example 12 was manufactured and the performance of the capacitor was evaluated in the same manner as in Example 3, except that nitrobenzaldehyde was used instead of nitroacetophenone. In the liquid material phase according to Example 12, the proportion of polyethylene glycol which is pentaethylene glycol (PEG-5) or larger in the polyethylene glycol was 0% by mass. The results are shown in Table 3 below.

TABLE 3

| | | | | | Evaluation results (135° C. 500 hours) | | | | | | | | |
|---|---|---|---|---|---|---|---|---|---|---|---|---|---|
| | | | | | CAP (120 Hz) | | | tan δ (120 Hz) | | | ESR (100 kHz) | | |
| | | | | | | | (After | | | (After | | | (After |
| | Composition | | | | | | durability | | | durability | | | durability |
| | | Aromatic Nitro | | | | After | test - Before | | After | test/ | | After | test/ |
| | PEG-3 | compound | | water | | dura- | durability | | dura- | Before | | dura- | Before |
| | Content | | Content | Content | | bility | test)/Before | | bility | durability | | bility | durability |
| | mass | Type | mass | mass | Initial | Test | durability test | Initial | Test | test | Initial | Test | test |
| | % | — | % | % | μF | μF | % | % | % | — | mΩ | mΩ | — |
| Ex. 7 | 94.0 | Nitrobenzoic acid | 5.0 | 1.0 | 254.8 | 225.1 | −11.64 | 2.13 | 2.63 | 1.23 | 10.77 | 13.26 | 1.23 |
| Ex. 8 | 94.0 | Nitrobenzyl | 5.0 | 1.0 | 254.7 | 225.6 | −11.45 | 2.08 | 2.98 | 1.43 | 10.84 | 15.02 | 1.39 |
| | | alcohol | | | | | | | | | | | |
| Ex. 9 | 89.0 | Nitrobenzyl | 10.0 | 1.0 | 255.5 | 223.7 | −12.43 | 2.07 | 3.04 | 1.47 | 11.10 | 16.01 | 1.44 |
| | | alcohol | | | | | | | | | | | |
| Ex. 10 | 94.0 | Nitrophenol | 5.0 | 1.0 | 256.0 | 225.0 | −12.09 | 2.06 | 3.39 | 1.64 | 10.75 | 28.04 | 2.61 |
| Ex. 11 | 89.0 | Nitrophenol | 10.0 | 1.0 | 255.9 | 224.0 | −12.47 | 2.10 | 3.87 | 1.84 | 10.80 | 37.77 | 3.50 |
| Ex. 12 | 94.0 | Nitrobenz | 5.0 | 1.0 | 255.5 | 223.6 | −12.48 | 2.10 | 3.28 | 1.57 | 11.06 | 15.74 | 1.42 |
| | | aldehyde | | | | | | | | | | | |
| Comp. | 99.0 | — | 0.0 | 1.0 | 255.0 | 35.8 | −85.96 | 2.10 | 238.0 | 113.3 | 11.06 | 34277 | 3099 |
| Ex. 3 | | | | | | | | | | | | | |

From Table 3, it is understood that the effect shown in Table 1, i.e., the effect that the properties as a capacitor are well maintained after durability test by using nitroacetophenone as an aromatic nitro compound and a lower percentage (mass %) of PEG-5 or larger, is obtained even when aromatic nitro compounds other than nitroacetophenone are used.

### Examples 13 to 16

In Examples 13 to 16, PEG-3 and nitroacetophenone were contained, and the water content was changed to various values.

The capacitors according to Examples 13 to 16 were manufactured and the performance of the capacitors was evaluated in the same manner as in Example 3, except that the contents of PEG-3 and water were changed as shown in Table 4 below. In the liquid material phase according to Examples 13 to 16, the proportion of polyethylene glycol which is pentaethylene glycol (PEG-5) or larger in the polyethylene glycol was 0% by mass. The results are shown in Table 4 below.

TABLE 4

| | | | | Evaluation results (135° C. 500 hours) | | | | | | | | |
|---|---|---|---|---|---|---|---|---|---|---|---|---|
| | | | | CAP (120 Hz) | | | | | | ESR (100 kHz) | | |
| | | | | | | (After | tan δ (120 Hz) | | | | | (After |
| | | | | | | durability | | | (After | | | durability |
| | Composition | | | | After | test - Before | | After | durability | | After | test/ |
| | | Nitro | | | dura- | durability | | dura- | test/Before | | dura- | Before |
| | | aceto- | | | bility | test)/Before | | bility | durability | | bility | durability |
| | PEG-3 | phenone | water | Initial | Test | durability test | Initial | Test | test | Initial | Test | test |
| | mass % | mass % | mass % | [μF] | [μF] | [%] | [%] | [%] | — | [mΩ] | [mΩ] | — |
| Ex. 13 | 95.0 | 5.0 | 0.0 | 256.0 | 227.1 | −11.26 | 2.12 | 2.70 | 1.27 | 11.25 | 13.90 | 1.24 |
| Ex. 3 | 94.0 | 5.0 | 1.0 | 255.4 | 226.9 | −11.18 | 2.10 | 2.68 | 1.28 | 11.19 | 13.81 | 1.23 |
| Ex. 14 | 93.0 | 5.0 | 2.0 | 256.9 | 227.9 | −11.29 | 2.14 | 2.71 | 1.27 | 10.87 | 14.28 | 1.31 |
| Ex. 15 | 92.0 | 5.0 | 3.0 | 258.7 | 228.5 | −11.67 | 2.15 | 2.72 | 1.27 | 10.86 | 14.06 | 1.29 |
| Ex. 16 | 90.0 | 5.0 | 5.0 | 260.1 | 229.4 | −11.78 | 2.16 | 2.75 | 1.27 | 10.84 | 14.71 | 1.36 |

From Table 4, it is understood that the effect shown in Table 1, i.e., the effect that the properties as a capacitor are well maintained even after durability test by using nitroacetophenone as an aromatic nitro compound and a lower percentage (by mass) of PEG-5 or larger, can be obtained even when the amount of water is changed.

### Example 17A to 20A and Comparative Example 4A to 5A

In Example 17A to 20A and Comparative Example 4A to 5A, the contents of components were changed to various values and evaluations were performed in a liquid material phase containing PEG-3, nitroacetophenone and water, as shown in Table 5 below.

In the durability test, the performance of a capacitor was evaluated after the capacitor was allowed to stand at 135° C. for 60 hours with 42V voltage being applied to the capacitor.

The results are shown in Table 5 below.

### Example 17B to 20B and Comparative Example 4B to 5B

In Example 17B to 20B and Comparative Example 4B to 5B, the performance of capacitors was evaluated in the same manner as in Example 17A to 20A and Comparative Example 4A to 5A, respectively, except that the duration of the durability test was changed from 60 hours to 80 hours. The results are shown in Table 6 below.

TABLE 5

| | | | | | Evaluation results (135° C. 60 hours) | | | | | | | | |
|---|---|---|---|---|---|---|---|---|---|---|---|---|---|
| | | | | | CAP (120 Hz) | | | tan δ (120 Hz) | | | ESR (100 kHz) | | |
| | | | | | | | (After | | | (After | | | (After |
| | Composition | | | | | | durability | | | durability | | | durability |
| | | Aromatic nitro | | | | After | test - Before | | After | test/ | | After | test/ |
| | PEG-3 | compound | | water | | dura- | durability | | Dura- | Before | | dura- | Before |
| | Content | | Content | Content | | bility | test)/Before | | bility | durability | | bility | durability |
| | mass | Type | mass | mass | Initial | test | durability test | Initial | test | test | Initial | test | test |
| | % | — | % | % | μF | μF | % | % | % | — | mΩ | mΩ | — |
| Ex. 17A | 90.0 | Nitro | 5.0 | 5.0 | 254.0 | 251.5 | −1.01 | 2.00 | 2.48 | 1.24 | 10.66 | 12.03 | 1.13 |
| | | acetophenone | | | | | | | | | | | |
| Ex. 18A | 97.0 | Nitro | 2.0 | 1.0 | 253.4 | 251.2 | −0.87 | 1.97 | 2.46 | 1.25 | 11.10 | 12.52 | 1.13 |
| | | acetophenone | | | | | | | | | | | |
| Ex. 19A | 97.5 | Nitro | 1.5 | 1.0 | 253.3 | 251.3 | −0.79 | 2.02 | 2.53 | 1.25 | 10.71 | 12.36 | 1.15 |
| | | acetophenone | | | | | | | | | | | |
| Ex. 20A | 98.0 | Nitro | 1.0 | 1.0 | 253.5 | 250.5 | −1.18 | 1.94 | 2.63 | 1.36 | 10.62 | 13.63 | 1.28 |
| | | acetophenone | | | | | | | | | | | |
| Ex. 4A | 98.5 | Nitro | 0.5 | 1.0 | 253.2 | 154.7 | −38.89 | 1.94 | 63.1 | 32.6 | 11.04 | 998.48 | 90.4 |
| | | acetophenone | | | | | | | | | | | |
| Ex. 5A | 99.0 | — | 0.0 | 1.0 | 253.3 | 63.3 | −75.01 | 2.01 | 168.6 | 84.0 | 10.76 | 12535.86 | 1164.8 |

TABLE 6

| | | | | | Evaluation results (135° C. 80 hours) | | | | | | | | |
|---|---|---|---|---|---|---|---|---|---|---|---|---|---|
| | | | | | CAP (120 Hz) | | | | | | | | |
| | | | | | | | (After | tan δ (120 Hz) | | | ESR (100 kHz) | | |
| | Composition | | | | | | durability | | | (After | | | (After |
| | | Aromatic nitro | | | | After | test - Before | | After | durability | | After | durability |
| | PEG-3 | compound | | water | | dura- | durability | | Dura- | test/Before | | dura- | test/Before |
| | Content | | Content | Content | | bility | test)/Before | | bility | durability | | bility | durability |
| | mass | Type | mass | mass | Initial | test | durability test | Initial | test | test | Initial | test | test |
| | % | — | % | % | μF | μF | % | % | % | — | mΩ | mΩ | — |
| Ex. 17B | 90.0 | Nitro | 5.0 | 5.0 | 254.0 | 247.4 | −2.59 | 2.00 | 2.49 | 1.24 | 10.66 | 12.30 | 1.15 |
| | | acetophenone | | | | | | | | | | | |
| Ex. 18B | 97.0 | Nitro | 2.0 | 1.0 | 253.4 | 247.4 | −2.39 | 1.97 | 2.47 | 1.25 | 11.10 | 12.76 | 1.15 |
| | | acetophenone | | | | | | | | | | | |
| Ex. 19B | 97.5 | Nitro | 1.5 | 1.0 | 253.3 | 247.9 | −2.14 | 2.02 | 2.53 | 1.25 | 10.71 | 12.80 | 1.20 |
| | | acetophenone | | | | | | | | | | | |
| Ex. 20B | 98.0 | Nitro | 1.0 | 1.0 | 253.5 | 194.2 | −23.38 | 1.94 | 40.6 | 21.0 | 10.62 | 553.29 | 52.1 |
| | | acetophenone | | | | | | | | | | | |
| Comp. | 98.5 | Nitro | 0.5 | 1.0 | 253.2 | 87.4 | −65.47 | 1.94 | 146.2 | 75.5 | 11.04 | 8046.74 | 728.9 |
| Ex. 4B | | acetophenone | | | | | | | | | | | |
| Comp. | 99.0 | — | 0.0 | 1.0 | 253.3 | 56.4 | −77.75 | 2.01 | 222.8 | 111.0 | 10.76 | 20980.58 | 1949.5 |
| Ex. 5B | | | | | | | | | | | | | |

As can be seen in Tables 5 and 6, it is understood that the effect, i.e., the effect that the properties of a capacitor are well maintained even after durability test by using nitroacetophenone as an aromatic nitro compound and a lower percentage (by mass) of PEG-5 or larger, is obtained when the nitroacetophenone content is 1.0 to 5.0% by mass, while the effect is not obtained when the nitroacetophenone content is 0.5% by mass or when the nitroacetophenone is not contained.

As can be seen in Table 6, a capacitor having a nitroacetophenone content of 1.0% by mass exhibited a slight decrease in durability test conducted over 80 hours, but exhibited excellent durability as compared to a case when the nitroacetophenone content was 0.5% by mass or when no nitroacetophenone was contained. The Capacitors with nitroacetophenone content of 1.5 to 5.0% by mass showed very good durability even in the durability test conducted for the duration of 80 hours.

### DESCRIPTION OF REFERENCE SIGNS

1 Electrolytic capacitor
10 Metal case
20 Capacitor element
21 Anode foil
22,24 Oxide film
23 Cathode foil
25 Separator
26 Solid electrolyte phase
27 Liquid material phase
29,30 Lead
40 Sealing member

1. An electrolytic capacitor having;
an anode foil with an oxide film formed on the surface thereof,
a cathode foil and
a separator disposed between the anode foil and the cathode foil,
wherein the electrolytic capacitor comprises, in a gap between the anode foil and the cathode foil:
a solid electrolyte phase comprising an electrically-conductive polymer compound, and
a liquid material phase comprising a liquid material,
characterized in that:
the liquid material phase comprises an aromatic nitro compound in an amount of 1.0% by mass or more,
the liquid material is polyethylene glycol and
in the polyethylene glycol, the proportion of polyethylene glycol which is pentaethylene glycol or larger is 30% by mass or less.

2. The electrolytic capacitor according to claim 1, wherein the liquid material phase comprises water in an amount of 0.1% by mass to 10% by mass.

3. The electrolytic capacitor of claim 1, wherein the aromatic nitro compound is selected from the group consisting of nitrophenol, nitroacetophenone, nitrobenzyl alcohol, nitrobenzoic acid, and nitrobenzaldehyde.

4. The electrolytic capacitor according to claim 1, wherein the solid electrolyte phase comprises polyethylene dioxythiophene as the electrically-conductive polymer compound and polystyrene sulfonic acid as a dopant.

5. A method for manufacturing an electrolytic capacitor, comprising:
forming a capacitor element by superposing and winding an anode foil and a cathode foil via a separator, wherein the anode foil has an oxide film formed on the surface thereof and the cathode foil is optionally treated with an etching process;
impregnating the capacitor element with an aqueous solution or dispersion of an electrically-conductive polymer compound, in order to form a solid electrolyte phase in a gap between the anode foil and the cathode foil; and
after the formation of the solid electrolyte phase, impregnating the capacitor element with a liquid material phase comprising a liquid material,
characterized in that:
the liquid material phase comprises an aromatic nitro compound in an amount of 1.0% by mass or more,
the liquid material is polyethylene glycol and
in the polyethylene glycol, the proportion of polyethylene glycol which is pentaethylene glycol or larger is 30% by mass or less.
